(19) United States
(12) Patent Application Publication
(10) Pub. No.: US 2006/0239648 A1
(43) Pub. Date: Oct. 26, 2006

(54) System and method for marking and tagging wireless audio and video recordings

(76) Inventor: Kivin Varghese, Clayton, NC (US)

Correspondence Address: ANDREW MCALEAVEY, 4600 ADELINE ST., #101, EMERYVILLE, CA, 94608, US

(21) Appl. No.: 11/428,812

(22) Filed: Jul. 5, 2006

Related U.S. Application Data
(63) Continuation-in-part of application No. 10/709,221, filed on Apr. 22, 2004.
(60) Provisional application No. 60/464,377, filed on Apr. 22, 2003.

(51) Int. Cl. H04N 7/00

(52) U.S. Cl. 386/95

(57) ABSTRACT

A system and method for audio/visual (A/V) recording in which A/V data is continuously recorded and selected segments of A/V data are marked, tagged, categorized, and archived. Archived segments of A/V data may be shared among users using a social networking scheme over a communications network, such as the Internet. The audiovisual recording devices generally connect wirelessly to a base station or a remote storage system, and recording functionality may also be vested in a variety of other devices.

### CROSS-REFERENCE TO RELATED APPLICATIONS

This application is a continuation-in-part of U.S. patent application Ser. No. 10/709,221, filed on Apr. 22, 2004, which claims priority to U.S. Provisional Patent Application No. 60/464,377, filed on Apr. 22, 2003. The entirety of U.S. patent application Ser. No. 10/709,221 is incorporated by reference herein.

### BACKGROUND OF THE INVENTION

1. Field of the Invention

The present invention relates generally to the field of wireless audio/video recording systems. More specifically, the present invention is related to marking and cataloging recorded audio/visual (A/V) data.

2. Description of Related Art

Traditional analog and digital handheld recording devices are inconvenient in that they require a user to physically bring a recording device to a location where they wish to record an event, power the device on, and steady the recording device in the appropriately angled direction. Moreover, once the event is recorded, the user is typically left to devise a way in which to index and store the video so that it is accessible for future viewing.

Various methods exist for placing index data on a recording medium at particular points. For example, many conventional film and digital cameras can place the date that a picture was taken on the picture itself, and some recording devices, like digital versatile disk (DVD) recorders and videocassette recorders (VCRs) can place an index marker on the recording medium when they begin recording so that the beginning of a recording can be easily found during playback. However, these index markers may or may not have any meaning to the user, and may or may not help the user to identify the event that was recorded and details associated with the event.

With the rise of video enabled cellular telephones, the Internet, and myriad other connectivity technologies, more and more users are producing, storing, and sharing video. Unfortunately, methods of dealing with all of that video are haphazard: there are a plethora of video storage formats; multiple, non-compatible video and photograph display websites competing for users; and very few video archival standards in the consumer market.

### SUMMARY OF THE INVENTION

One aspect of the invention relates to an audiovisual recording system. The audiovisual recording system comprises an audiovisual recording device and a storage system coupled to the audiovisual recording device. The audiovisual recording device is adapted to continuously record audiovisual data, and is further adapted to allow particular segments of audiovisual data to be tagged and associated with user-defined index data. The storage system is coupled to the audiovisual recording device through a communication network and is adapted to accept the particular segments of audiovisual data from the audiovisual recording device and to store those particular segments of audiovisual data.

Another aspect of the invention relates to a method for archiving selected segments of audiovisual data. The method comprises continuously recording audiovisual data via an audiovisual recording device, allowing selected segments of the audiovisual data to be marked and associated with user-defined index data, and transferring the selected segments of the audiovisual data to a storage system. The method also comprises allowing the selected segments of audiovisual data to be accessed.

Other aspects, features, and advantages will be set forth in the description that follows.

### BRIEF DESCRIPTION OF THE DRAWINGS

The invention will be described with reference to the following drawing figures, in which like numerals represent like elements throughout the figures, and in which:

FIG. 1 is a diagram of a system for marking and tagging audio and video according to one embodiment of the invention;

FIG. 2 is a block diagram of the elements of an audiovisual recording device according to one embodiment of the invention;

FIG. 3 is a block diagram of the elements of an audiovisual recording device according to another embodiment of the invention;

FIG. 4 is a perspective view of the audiovisual recording device of FIG. 2;

FIG. 5 is a front elevational view of the audiovisual recording device of FIG. 3;

FIG. 6 is a rear elevational view of the audiovisual recording device of FIG. 3;

FIG. 7 is a diagram of a system for marking and tagging audio and video according to another embodiment of the invention;

FIG. 8 is a flow diagram of a method for marking and tagging audio and video according to an embodiment of the invention; and

FIG. 9 is an illustration of a screen that forms part of a user interface for viewing, searching, and sharing video segments.

### DETAILED DESCRIPTION

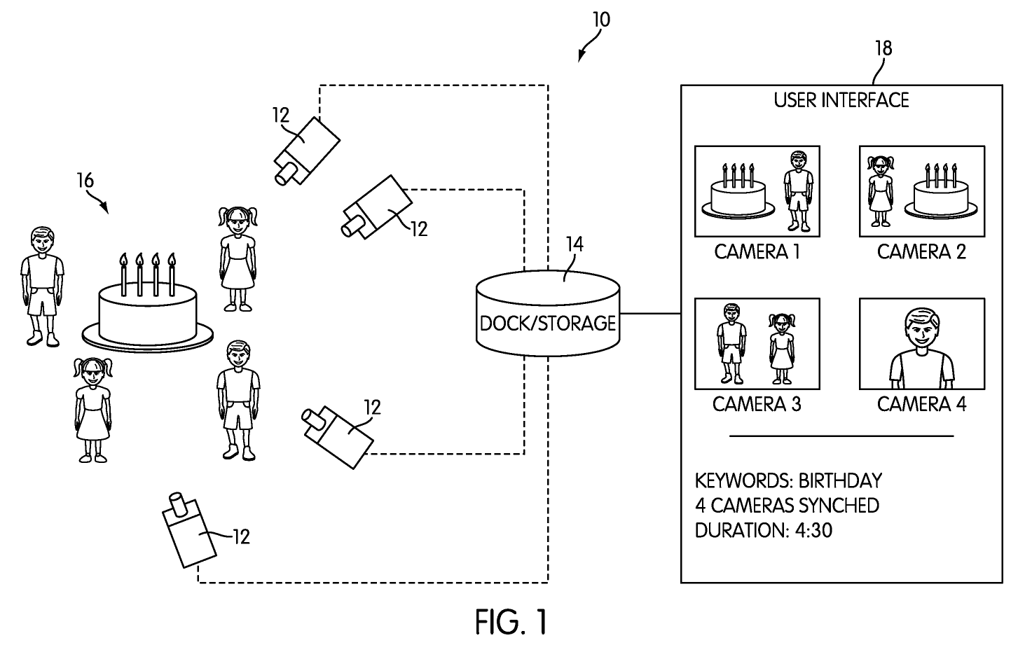

FIG. 1 is diagram of a system, generally indicated at 10, according to one embodiment of the invention. System 10 is a system for marking and tagging audio and video recordings. There are two basic components to system 10: an audiovisual recording device 12 or a number of audiovisual recording devices 12 that are adapted to continuously record audiovisual data and to allow particular segments of audiovisual data to be tagged and associated with user-defined index data (either in real time or at some other point), and a storage system 14 coupled to the audiovisual recording devices 12.

In one embodiment, using a system such as system 10, the audiovisual recording devices 12 are always recording. They may, for example, be attached to a user's arm or shoulder by appropriate straps; they may be attached to a tripod or an object; they may be handheld; or they may be attached to another object or part of the body. Therefore, the audiovisual recording devices 12 constantly capture video and audio data from the place in which they are mounted or held. It should also be understood that in some embodiments, the audiovisual recording devices may capture only audio, only video, or a continuous series of still photographs, and that the term “video” as used here, may refer to any or all of those combinations. When something worthy of note occurs, is about to occur, or has occurred, the user indicates that the video is to be tagged for saving. Either before, in real time, or after the fact, the user may also associate a tagged segment of video with one or more keywords, phrases, or other user-defined index data for use in later search and retrieval. These aspects of system 10 will be described below in more detail. The storage system 14 is coupled to the audiovisual recording devices 12 such that at least the tagged segments are uploaded, downloaded, sent, or otherwise transferred to the storage system 14 with the user-defined index data.

As shown in FIG. 1, four audiovisual recording devices 12 are focused on the same event 16, each of the audiovisual recording devices 12 recording the event 16 from a different perspective. For example, one camera may be resting on a user's shoulder, another camera may be resting on another user's shoulder, and the third and fourth cameras may be mounted in fixed locations and focused on the event 16 from particular perspectives. In FIG. 1, the event 16 is a birthday party, and each camera is focused on a different group of party attendees.

The audiovisual recording devices 12 may or may not belong to the same user. As will be described below in more detail, multiple cameras belonging to the same user or different users can be synchronized to tag and save the same video segments and to index those segments with the same user-defined index data.

In system 10, the storage system 14 may be a standalone docking station with an interface, such as a universal serial bus (USB) interface port (Compaq Computer et al., “Universal Serial Bus Specification, Revision 2.0” (2000), the contents of which are incorporated by reference herein) or a FireWire port (Institute of Electrical and Electronics Engineers, “IEEE Standard 1394-1995 IEEE Standard for a High Performance Serial Bus” (1995), the contents of which are incorporated by reference herein) that is adapted to interface with a complementary interface on the audiovisual recording devices 12. If the storage system 14 provides such a wired connection, the individual audiovisual recording devices 12 would generally have enough built-in storage space such that they can continuously record and tag video segments and operate for relatively long stretches of time without being connected to the storage system 14. Embodiments in which the interface between the storage system 14 and the audiovisual recording device 12 is wireless will be described below; in these embodiments, audiovisual data may be sent continuously or at defined intervals to the storage system 14. The storage system 14 itself most advantageously includes enough storage space for a lifetime of video segments.

Parent U.S. patent application Ser. No. 10/709,221 discloses embodiments in which a pocketpak acts as a user interface and as an intermediate storage device between the audiovisual recording device 12 (disclosed in the prior application as a pencilcam) and the storage system 14. The pocketpak also allows a user to perform some tagging and playback functions. In system 10, the pocketpak or intermediate storage device is an optional feature; in most embodiments, the functionality of the pocketpak will be included directly in the audiovisual recording devices 12 or in the storage system 14.

In particularly advantageous embodiments, the audiovisual recording devices 12 communicate with and transfer information to the storage system 14 wirelessly, either at regular intervals (for example, every hour) or in real time. The communication between the audiovisual recording devices 12 may be by any known protocol, including wireless data exchange protocols like the wireless USB protocol (Agere et al., “Wireless Universal Serial Bus Specification, Revision 1.0” (2005), the contents of which are incorporated by reference herein), the Bluetooth protocol (Bluetooth Special Interest Group, “Specification of the Bluetooth System,” Version 2.0, the contents of which are incorporated by reference herein), WiFi wireless networking protocols (IEEE 802.11b/g and similar protocols), and WiMax. In one particular embodiment, the wireless data exchange may occur using the data transmission capabilities of a cellular telephone network.

The storage system 14 also provides a storage medium, such as a hard disk drive or a flash drive, and provides, serves, or creates a user interface 18, shown schematically in FIG. 1, that allows a user to view tagged segments of video and to perform other operations, such as categorizing and searching for video segments.

In order to provide, serve, or create the user interface 18, the storage system 14 may connect with a personal computing device (not shown in FIG. 1), such as a desktop computer, laptop computer, television set-top box, personal digital assistant (PDA), or cellular telephone by interfacing with the personal computing device such that the personal computing device and its components act as the user interface 18. Any of the protocols described above, or any other suitable protocols and interface hardware, may be used to interface the storage system 14 with a personal computing device.

If the standalone storage system 14 includes an interface device such as a modem, Ethernet adapter, WiFi adapter, WiMax adapter, cellular transceiver, general RF transceiver, or other communication interface device, it may be connected to a network, such as a household local area network, allowing it to provide the user interface 18 in a manner accessible to a number of personal computing devices. For example, the storage system 14 may be configured to provide the user interface 18 by transmitting hypertext pages using hypertext transfer protocol (HTTP) over a network, such as a household local area network. A storage system 14 that is so enabled could be accessed by any of the personal computing devices listed above with the use of a browser or other client application and without a direct, wired connection between the storage system 14 and the personal computing device.

Alternatively, the user interface 18 depicted schematically in FIG. 1 may comprise a viewing screen along with appropriate user controls that is integrated into or coupled to the storage system 14. The viewing screen may be, for example, a liquid crystal display (LCD), a conventional cathode ray tube (CRT) display or a plasma viewing screen along with appropriate keys or other buttons that would allow the user to access the video segments and perform other functions.

In some embodiments, the functionality of the storage system 14 and its user interface 18 may be included in a personal computing device, a home theater system, or another audiovisual system.

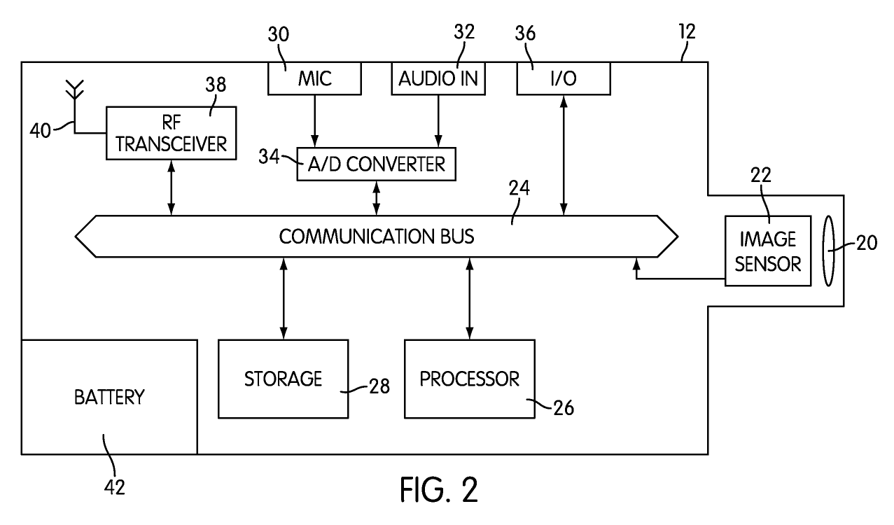

FIG. 2 is a block diagram of the elements of an audiovisual recording device 12. The audiovisual recording device 12 includes an optical system, generally indicated at 20, that includes one or more lenses to focus incoming light, and may include motors, telescoping portions, shutters, and any other conventional photographic optical system components. The optical system 20 is coupled to an image sensor 22, such as a charge-coupled device (CCD), whose purpose it is to convert the impinging light into a digital form. The image sensor 22 and most other elements of the audiovisual recording device 12 are connected to a communication bus 24 that conveys signals between the various elements.

Connected to the communication bus 24 to manage and store images and video from the image sensor 22 are a processor 26 and storage 28. The processor 26 may be a general microprocessor, an integer microprocessor, a digital signal processor, an application-specific integrated circuit (ASIC), or any other processing element that is capable of performing the functions ascribed to it in this specification. Storage 28 may be any form of readable-writeable electronic storage, including a hard disk drive (HDD), RAM, or a flash drive. In some cases, storage 28 may also include read-only memory with operating system software or another form of basic instruction set, such as conventional read-only memory (ROM), programmable read-only memory (ROM) or electrically erasable programmable read-only memory (EEPROM).

The optical system 20, image sensor 22, communication bus 24, processor 26, and storage 28 allow the audiovisual recording device 12 to accept and store video. An internal microphone 30 and external audio input jack 32 allow the audiovisual recording device 12 to accept audio input. The internal microphone 30 and audio input jack 32 are connected to an analog-to-digital converter 34 that converts analog audio signals to digital form. The analog-to-digital converter 34 is, in turn, connected to the communication bus 24 to transfer the digitized audio signals to the other components of the audiovisual recording device 12.

The audiovisual recording device 12 also includes an input/output (IO) system 36. The I/O system 36 encompasses two types of elements: elements that allow the device 12 to accept commands from a user, such as commands to tag particular segments of video and associate keywords, and elements that allow the device 12 to communicate through a wired connection with other devices.

An RF transceiver 38 connected to the communication bus 24 provides for I/O operations through wireless communication protocols, including Bluetooth, WiFi, WiMax, and cellular telecommunication protocols, depending on the particular embodiment of audiovisual recording device 12. (In the case of cellular communication, the RF transceiver 38 may provide compatibility with any or all of CDMA, TDMA, GSM or next generation wireless protocols.) The RF transceiver 38 also includes an antenna 40, which may be an internal antenna or an external antenna, depending on the embodiment. Audiovisual recording device 12 may also include an infrared transceiver if it is to be compatible with infrared communication protocols. Additionally, the audiovisual recording device 12 may include multiple RF transceivers if it is to use multiple communication protocols that operate at different frequencies or require distinct hardware to operate. In some embodiments, the audiovisual recording device 12 may also include a global positioning system (GPS) receiver, so that the location of the audiovisual recording device 12 and date/time data can be recorded with the audiovisual data. Alternately, if the audiovisual recording device 12 is in communication with a cellular communication network, it may be programmed to establish its location by triangulation with reference to a number of nearby cell towers.

As shown in FIG. 2, a battery 42 or set of batteries provides power for the audiovisual recording device 12. The battery 42 may, for example, be a rechargeable lithium ion battery, a nickel-cadmium rechargeable battery, or a conventional disposable alkaline battery. Although not explicitly shown in FIG. 2, audiovisual recording device 12 may also be equipped to receive direct or alternating current from a wall outlet to recharge the battery 42 and to operate. An internal or external transformer may be provided if needed. Additionally, the audiovisual recording device could be configured to accept power from the storage system 14 through a connection with it.

With the arrangement of FIG. 2, video and audio data are received by the image sensor 22 and the microphone 30 or audio input jack 32 and are processed by the processor 26 before being stored in storage 28. For example, the processor 26 may synchronize the audio and video data, direct the optical system 22 to perform focusing tasks, perform color, balance, or other image correction tasks, compress the audio and video together, and store them in the storage 28. Video may be stored using any compression-decompression CODEC, including the MPEG (Motion Picture Experts Group), QuickTime, and AVI CODECs, to a name a few.

The processor 26 is also responsive to commands, such as commands to tag video, from the I/O system 36 or from other sources. In some embodiments, if the I/O system 36 includes keys, buttons, or switches, the processor 26 may be responsive to execute commands when those keys, buttons, or switches are depressed. However, in some embodiments, the audiovisual recording device 12 may be configured to accept verbal (i.e. voice) commands through the microphone 30. In that case, after the audio signals are converted to digital form by the analog-to-digital converter 34, they may be processed by the processor 26 to search for and execute commands voiced by the user. A number of voice-recognition algorithms are known in the art, and any of these may be used in embodiments of the present invention.

Depending on the voice-recognition algorithm and the implementation, a user may input commands only, keywords only, or keywords and commands by voice. In order to facilitate understanding of the user's voice and commands, a user may be asked to “train” the audiovisual recording device 12 to recognize his or her speech. In that case, training algorithms may be stored in the storage 26, and the user's particular way of speaking various commands, or their parsed representations, may be stored in the storage 28 for later use in recognizing spoken commands. A user may be asked to press a button or to speak a specific prefatory phrase before audiovisual recording device 12 will accept voice commands.

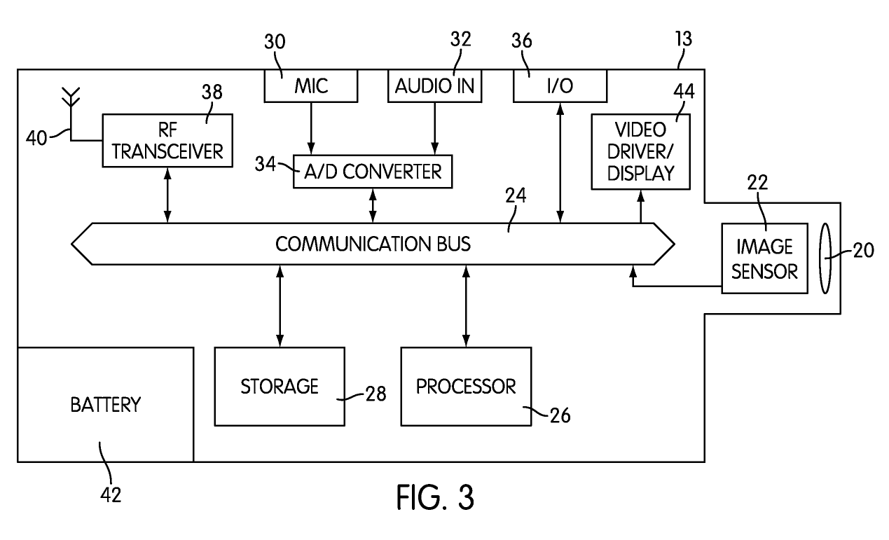

FIG. 3 is a block diagram of the elements of another audiovisual recording device 13. Audiovisual recording device 13 is similar to audiovisual recording device 12 and, therefore, the description provided above applies equally to it. However, in addition to the components described above, audiovisual recording device 13 includes a video driver and display system 44. The video driver and display system 44 may be used to display segments of video as they are being recorded and it may be used in selecting, tagging and associating keywords with recorded segments of video.

Additionally, in some embodiments, the video driver and display system 44 may be used to take input from the user, in the manner of a touch screen. Touch screens and handwriting recognition are known in the art, and any method and structures for accepting input from the video driver and display system 44 may be used. Generally, a display equipped for touch-screen input includes a layer of transparent electrodes made, for example, with indium-tin oxide (ITO) that respond to pressure by generating an electrical signal.

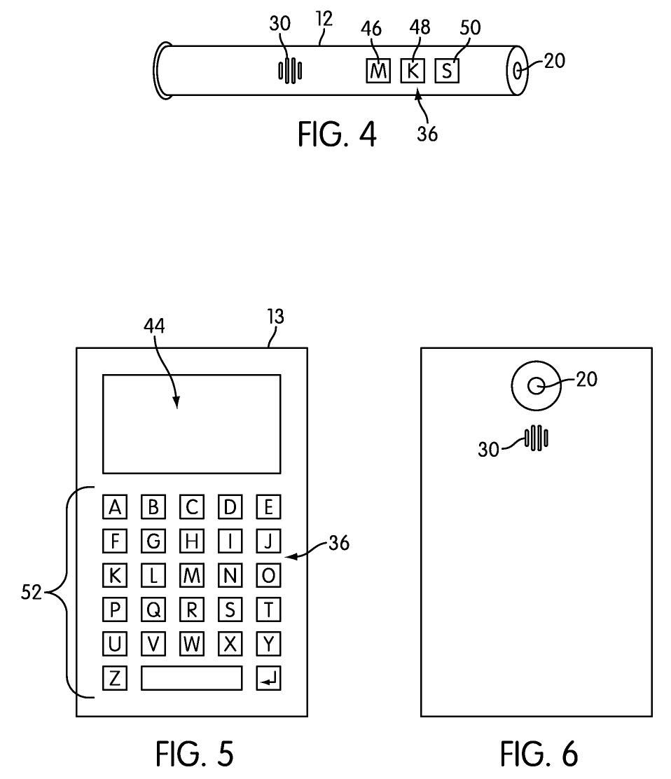

FIGS. 4-6 are exemplary illustrations of various embodiments of the audiovisual recording devices 12, 13. Specifically, FIG. 4 is a perspective view of an audiovisual recording device 12 without a video driver and display system 44 and FIGS. 5 and 6 are front and rear elevational views, respectively, of an audiovisual recording device 13 with a video driver and display system 44.

The audiovisual recording device 12 illustrated in FIG. 4 is a relatively slender, elongate, generally cylindrical device with a lens 20 on the front end face. Arrayed along the side edge of the device 12 are a microphone 30 and several keys 46, 48, 50, which comprise parts of the I/O system. The other components shown schematically in FIG. 2 are within the housing of the device 12.

Since the audiovisual recording device 12 of FIG. 4 has no video driver and display system 44 and only a limited set of keys 46, 48, 50, the user would interact with the audiovisual recording device 12 largely by speaking voice commands, which would be received by the microphone 30 and processed as was described above. Depending on the voice recognition software, no further inputs may be needed. However, if desired, the audiovisual recording device 12 of FIG. 4 could include a small, simple liquid crystal display, like that found on a calculator, or another indicator device, in order to display basic status information.

FIG. 4 illustrates one embodiment of an audiovisual device 12 that provides an “M” key 46, which the user would press manually to mark a segment of video, a “K” key 48, which the user would press before speaking keywords to indicate that those keywords are to be associated with the marked segment of video, and an “S” key 50, which the user would press to synchronize with other audiovisual recording devices 12, 13 in the area. Other button and keying schemes may be used in other embodiments of the invention.

Once synchronized, an input to one of the audiovisual recording devices 12, 13 would be conveyed to the other audiovisual recording devices 12, 13 for appropriate action. The “S” key 50, may, for example, establish Bluetooth connectivity between audiovisual recording devices 12, 13 in the local area, with the other audiovisual recording devices 12, 13 slaved to one of the devices 12, 13. Keywords entered via one audiovisual recording device 12, 13 would then be associated with the video from all of the audiovisual recording devices 12, 13. Of course, as was described above, the command to synchronize multiple audiovisual recording devices 12, 13 may be given vocally or by any other input means recognized by the audiovisual device 12, 13 in question.

The audiovisual recording device 13 of FIGS. 5 and 6 does include a video driver and display system 44, as well as a fuller keyboard 52. The lens 20 and microphone 30 are provided on the opposite face of the device 13. The user can thus use the keyboard 52 to control and activate functions of the audiovisual recording device 13, to mark and provide keywords for segments of video, and to synchronize with other audiovisual recording devices 12, 13. In some embodiments, if the video driver and display system 44 is equipped for touch-screen input, the keyboard 52 may be partially or wholly absent.

FIGS. 2-6 illustrate particular embodiments of audiovisual recording devices 12, 13. However, the functionality of the audiovisual recording devices 12, 13 may be incorporated into other devices. For example, a conventional digital camera may be provided with the capability to act as an audiovisual recording device 12, 13 according to the present invention, as may a cellular telephone.

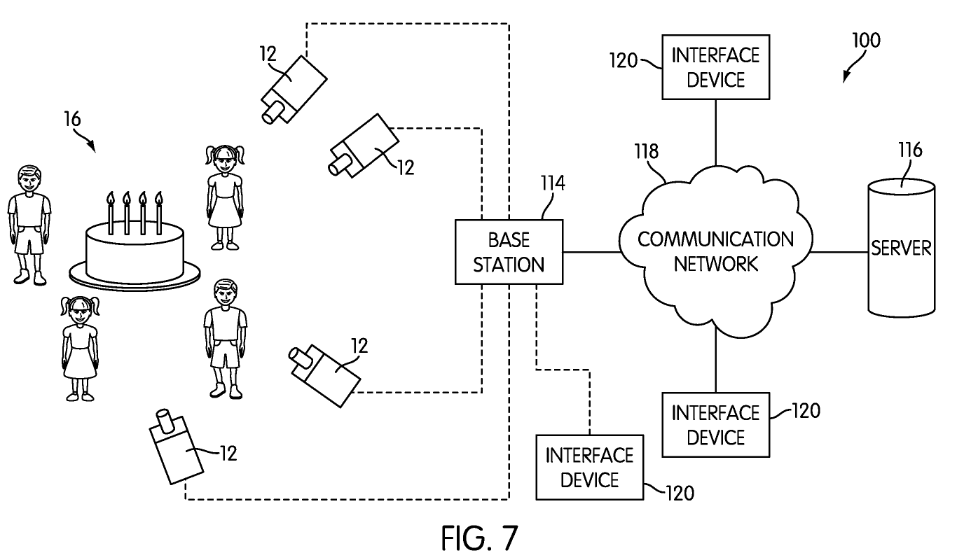

In the description above of system 10, it was assumed that the storage system 14 was local to the audiovisual recording devices 12 and under the control of a single user. However, this need not be the case. FIG. 7 is a diagram of a system 100 for marking and tagging audio and video according to another embodiment of the invention.

In FIG. 7, a plurality of audiovisual recording devices 12 are illustrated recording the same event 16. As with system 10, any number of audiovisual recording devices 12 may be used in system 100, those audiovisual recording devices 12 generally record continuously, and a plurality of them may or may not record synchronously, with the same user-defined index data associated with the recordings of all of the plurality of the cameras.

In system 100, the audiovisual recording devices 12 are in communication, most advantageously wireless communication, with a base station 114. Base station 114 may or may not have some or all of the functionality of the storage system 14 of system 10.

In one particularly advantageous embodiment, base station 114 may be a part of or coupled to a cellular communication network transmission tower or station, such that the audiovisual recording devices 12 are in communication with the base station 114 through a cellular communication network. The cellular communication network may be the same network used to carry data from cellular telephones.

The base station 114 is, in turn, in communication with a storage system 116 by way of a communication network 118. Thus, the base station 114 would typically receive data from the audiovisual recording devices 12 through a cellular or wireless data communication network and transfer that data to the storage system 116 using, for example, its own high speed Internet connection. A number of interface devices 120 are also connected to the communication network 118 and are thus able to access the storage system 116 through the communication network 118.

Those of skill in the art will realize that the presence of the base station 114 in system 100 may or may not be apparent to the end user of system 100. Particularly if the base station 114 is coupled to a cellular or other large-area wireless data network, the base station 114 may or may not be under the control of the end user, and its presence may be invisible to the end user; for all intents and purposes, the audiovisual recording devices 12 may appear to connect directly to the communication network 118. In other embodiments, if the communication network 118 itself is entirely wireless, the base station 114 may be omitted and the audiovisual recording devices 12 may connect directly to the communication network 118 with no intermediary.

Instead of being stored and processed locally, as in system 10, system 100 allows tagged video segments and their associated keywords to be stored remotely. Users can then access their video segments through an interface device 120. An interface device 120 may be any of the personal computing devices described above. For example, a user might access video segments through a personal computer connected to the communication network 118, or through a data-enabled cellular telephone capable of accessing the communication network 118.

System 100 has the advantage of aggregation. More than one user, base station 114, or set of audiovisual recording devices 12 may be connected to the same storage system 116 through the communication network 118. Furthermore, although shown as a single device, the storage system 116 may be a network of interconnected, cooperating storage devices. As is well known in the art, a number of cooperating storage devices may be interconnected so as to appear to be one unitary storage system 116 to other devices connected through the communication network 118.

Alternatively, individual storage systems 116 belonging to a number of users could be connected to one another in a distributed network, establishing a larger, collective storage system. All of these configurations would allow inter-user operability and the ability to share data under certain circumstances, which will be described below in more detail.

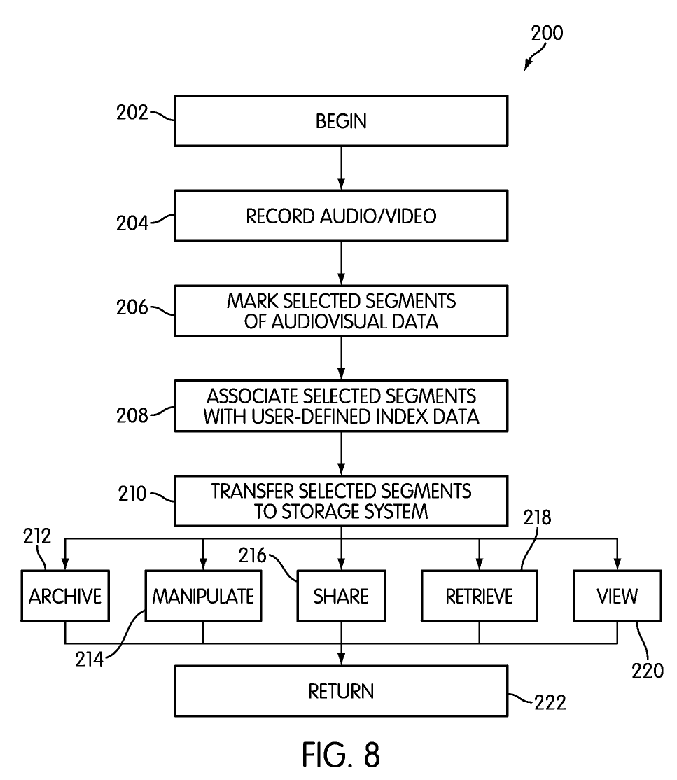

FIG. 8 is a flow diagram of a method, generally indicated at 200, for marking and tagging audio and video according to an embodiment of the invention. Either system 10 or system 100 may be used in the performance of method 200. Method 200 begins at 202 and continues with task 204. In task 204, the user continuously records with one or more audiovisual recording devices 12, 13 either synchronously or not. At desired intervals, as shown in task 206, the user marks selected segments of audiovisual data and then, as shown in task 208, associates those marked segments of audiovisual data with user-defined index data, such as selected keywords or phrases. Automatic index data, such as time, date, and location, may also be recorded.

Method 200 then continues with task 210, in which the selected segments of audiovisual data are transferred to a storage system 14 or storage system 116 along with the user-defined index data. As was described above, a user may provide the user-defined index data in real time as the audiovisual data is recorded, or the user may provide the user-defined index data at some other point, most advantageously prior to task 210.

In method 200, the treatment of non-selected segments of audiovisual data may vary from implementation to implementation. Generally, however, the treatment of non-selected (i.e., non-marked/non-tagged) segments of audiovisual data will be different from the treatment of the selected segments of audiovisual data. As one example, the non-marked audiovisual data could simply be overwritten as the audiovisual recording device 12, 13 continues to record.

However, if the non-marked audiovisual data is simply overwritten, a problem may arise if a user later decides that a portion of audiovisual data that was not previously marked is worthy of saving. By the time that decision is belatedly made, the portion of data in question may already have been overwritten, a frustrating situation for the user. Therefore, non-marked audiovisual data may be stored in a number of ways.

One option would be for all of the audiovisual data to be saved and stored, with the marked audiovisual data simply being more easily accessible using the user-defined index data. The non-marked segments may be stored with and indexed by automatically generated index data, such as the time and date of recording and, if the audiovisual recording device 12, 13 is equipped with a GPS receiver or another mechanism capable of establishing its location, the location of the audiovisual recording device 12, 13 at the time of recording.

Another option would be to store marked and non-marked segments of audiovisual data at different quality levels, with the marked segments usually stored at higher quality. As used here, the term “quality” refers in general to several characteristics of the audiovisual data, including resolution and compression level, and there are several ways in which the quality differential may be implemented.

Most conventional digital still and video cameras are capable of recording at different resolutions, with a higher resolution resulting in a larger physical or print image, and a smaller resolution resulting in a smaller physical or print image. Smaller resolution images also generally consume less storage space than similar larger resolution images.

Additionally, most audio and video storage CODECs incorporate some form of compression, which reduces the size of the resulting file for storage purposes. Non-marked segments of audiovisual data could be stored at higher compression levels than marked segments, such that they consumed less storage space.

In either case, the command to mark or tag video on the audiovisual recording device 12, 13 could also trigger a switch from low-quality recording to high-quality recording. Depending on the embodiment, the user may be able to define the quality levels at which the marked and non-marked segments of audiovisual data are stored.

In some embodiments, users may set rules to assist with the automatic tagging and saving of video data. For example, the user may program the audiovisual recording device 12 to tag and save one minute of recording out of every eight minutes of recording.

Once the selected segments of audiovisual data have been transferred to the storage system 14 or storage system 116 with their user-defined index data, they can be archived (task 212), manipulated (task 214), shared (task 216), retrieved (task 218) and viewed (task 220) any number of times before method 200 terminates at task 222.

Most advantageously, if system 100 is used with method 200 and the selected segments of audiovisual data are stored on a communal storage system 116, then tasks 212-220 of method 200 may be performed by creating a personalized data space for each user that allows a user to perform those tasks. This personalized data space may be created by the storage system 116 or other information systems in communication and cooperation with the storage system 116, and may be provided over the communication network 118 to the individual interface devices 120. For example, the communication network may be the Internet and the personalized data space may comprise one or more HTML or XML pages customized for the user and provided using HTTP.

In general, method 200 may be vested in a set of machine-readable instructions interoperable with a machine to perform the tasks of the method. Machine-readable instructions are typically encoded in a machine-readable medium, such as a hard disk drive, a floppy disk drive, a CD-ROM, a DVD, a FLASH drive, or another storage medium accessible by a machine.

Method 200 may also take on the functions and advantages of social networking, in which multiple individual users form social networks based on personal, professional, or other affiliations and share information through those networks. Using a social networking arrangement, selected audiovisual segments from one user that have particular keywords or other user-defined index data or that are from the same event or were taken at the same time and/or date may be shared with other interested users.

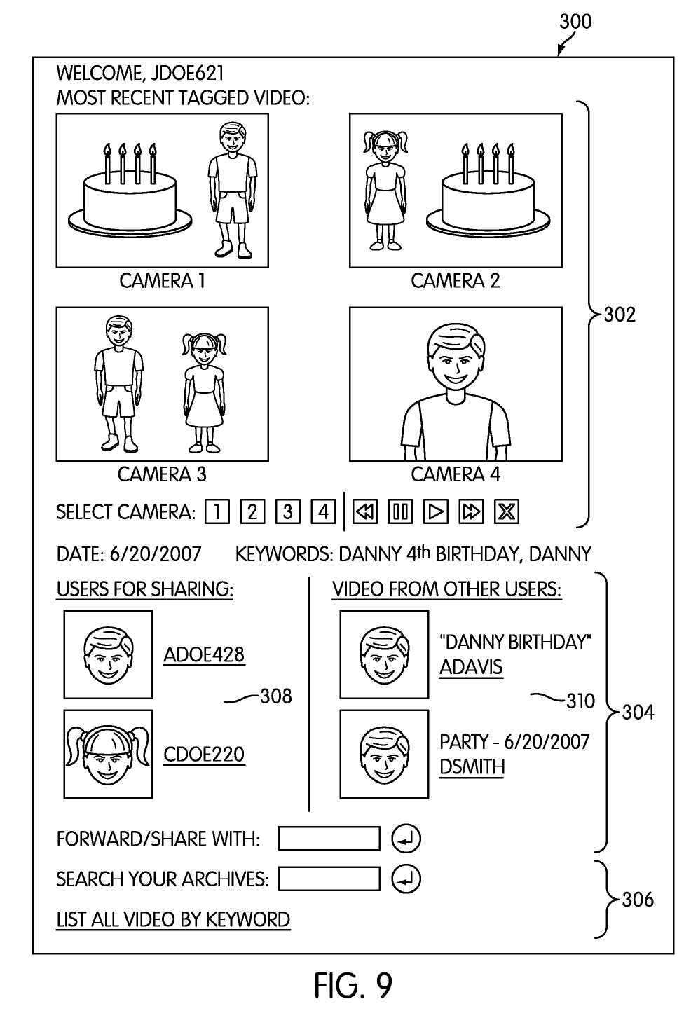

FIG. 9 is an illustration of a screen 300 that forms part of a user interface of a personalized data space for viewing, searching, and sharing video segments. Screen 300 includes a video playback area 302, a sharing area 304, and a search and retrieval area 306. Depending on the embodiment, screen 300 may be encoded in HTML or another machine-readable language and rendered using any of the personal computing devices described above.

The video playback area 302 allows a user to play back one or more of the selected segments of audiovisual data. Specifically, the illustration of FIG. 9 continues the example of FIGS. 1 and 7 and assumes that four cameras were used to record a birthday party. The video playback area 302 allows the user to select one or more of the cameras for playback, and includes common cueing functions, including fast-forward and rewind. The date that the video was taken and the user's keywords or other user-defined index data are also displayed.

Beneath the video playback area 302 in the illustration of FIG. 9 is the sharing area 304. The sharing area 304 has two portions, an access control portion 308 and a shared video portion 310.

In many cases, video captured by an individual user will be private, and the user may not wish to share that video with all other users who access the storage system 116. Therefore, access control portion 308 allows the user to set limits on which users can access and view the video segments. In the illustration of FIG. 9, for example, two users, adoe428 and cdoe220, are authorized to share and view the video segments currently displayed in the video playback area 302. This relatively simple permissions scheme may be adequate for some embodiments, while in other embodiments, more complex permissions schemes may be used. For example, a user may grant separate sets of permissions to different users for viewing and manipulating, so that one user may only be able to view a video segment, while another can view and edit or manipulate it.

The shared video portion 310 displays video from other users that the user has permission to view. The video from other users may be automatically matched with the video displayed in the video playback area 302 on the basis of keywords, date/time data, or location (e.g., GPS data), or it may be manually designated by the other user as related to the first user's video. In the exemplary illustration of FIG. 9, two users are offering their own video of the birthday party to the first user. Similarly, the user can enter a user name to share his or her video with that user.

The search and retrieval area 306 allows the user to search for particular segments of video by keyword. Although not shown in FIG. 9, in some embodiments, the user may also search by other automatic index data, including such as the date that the video was recorded, the length of the video, the user who recorded the video, or the geographical location of the audiovisual recording device 12 when the video was recorded.

Depending on the embodiment, the interface shown in screen 300 may also provide the user with options for manipulating the audiovisual data. For example, a user may be provided with the ability to add voice-over, captions or titles, and other common video elements, as well as the ability to edit or splice segments of video together. Users may also be provided with a mechanism for converting the video segments to other formats for viewing on other devices or in other formats. For example, users could be provided with the ability to burn selected segments of video to a local DVD. The personalized data space could also provide the ability to display video full screen, so that it can be displayed on a television or other such device.

The personalized data space illustrated in FIG. 9 may also include any features commonly found in social networks, including the ability to post video segments for public viewing and rating and the ability to download video segments.

Although the invention has been described with respect to certain embodiments, those embodiments are intended to be exemplary, rather than limiting. Modifications and changes may be made within the scope of the invention, which is determined by the claims.

What is claimed is:

1. An audiovisual recording system, comprising:
an audiovisual recording device adapted to continuously record audiovisual data, the audiovisual recording device being further adapted to allow particular segments of audiovisual data to be tagged and associated with user-defined index data; and
a storage system coupled to the audiovisual recording device through a communication network, the storage system being adapted to accept the particular segments of audiovisual data from the audiovisual recording device and to store those particular segments of audiovisual data.

2. The audiovisual recording system of claim 1, further comprising a plurality of audiovisual recording devices adapted to continuously and synchronously record the audiovisual data.

3. The audiovisual recording system of claim 2, wherein user-defined index data entered on one of the plurality of audiovisual recording devices is associated with the particular segments of audiovisual data on all of the plurality of audiovisual recording devices.

4. The audiovisual recording system of claim 2, further comprising a user interface that allows the user to view the particular segments of audiovisual data from the perspective of one or more of the plurality of audiovisual recording devices.

5. The audiovisual recording system of claim 4, wherein the user interface allows editing tasks on the particular segments of audiovisual data.

6. The audiovisual recording system of claim 4, wherein the user interface provides a search engine adapted to allow a user to search among the particular segments of audiovisual data using the user-defined index data.

7. The audiovisual recording system of claim 4, further comprising a personal computing device connected to the storage system through the communication network, wherein the user interface comprises a set of personalized data provided by the storage system to the personal computing device and interpreted by the personal computing device.

8. The audiovisual recording system of claim 4, wherein the user interface allows the user to grant selected other users permission to view the particular segments of audiovisual data through the user interface.

9. The audiovisual recording system of claim 8, wherein the user interface allows the user to build a social network.

10. The audiovisual recording system of claim 1, wherein the storage system stores audiovisual data recorded by the audiovisual recording device other than the particular segments of audiovisual data at a different quality level than the particular segments of audiovisual data.

11. The audiovisual recording system of claim 1, wherein the user-defined index data comprises at least one key word or at least one key phrase.

12. A method for archiving selected segments of audiovisual data, comprising:
continuously recording audiovisual data via an audiovisual recording device;
allowing selected segments of the audiovisual data to be marked and associated with user-defined index data;
transferring the selected segments of the audiovisual data to a storage system;
allowing the selected segments of audiovisual data to be accessed.

13. The method of claim 12, wherein the method further comprises:
synchronizing two or more audiovisual recording devices for continuous recording; and
allowing the selected segments of audiovisual data to be marked and associated with the same user-defined index data.

14. The method of claim 12, wherein the storage system stores the selected segments of audiovisual data from a plurality of audiovisual devices, some of the plurality of audiovisual devices belonging to different users.

15. The method of claim 14, further comprising allowing a user to selectively share the selected segments of audiovisual data with at least some of the different users.

16. The method of claim 12, wherein allowing the selected segments of audiovisual data to be accessed comprises allowing the selected segments of audiovisual data to be viewed.

17. The method of claim 12, further comprising allowing one or more users to establish a social network, within which the selected segments of audiovisual data can be selectively associated with one another and selectively shared.

18. The method of claim 12, wherein the storage system is connected to the audiovisual recording device through a communication network.

19. The method of claim 18, wherein at least a portion of the communication network is a wireless communication network.

20. The method of claim 12, further comprising:
storing the selected segments of audiovisual data at a higher quality than non-selected segments of audiovisual data.

21. The method of claim 12, further comprising overwriting or erasing non-selected segments of audiovisual data.
